(19) United States
(12) Patent Application Publication
(10) Pub. No.: US 2008/0126153 A1
(43) Pub. Date: May 29, 2008

(54) System and method for determination of executive compensation in a public company

(76) Inventor: Tara Chand Singhal, Torrance, CA (US)

Correspondence Address: Tara Chand Singhal, P O Box 5075, Torrance, CA, 90510, US

(21) Appl. No.: 11/605,041

(22) Filed: Nov. 28, 2006

(51) Int. Cl. G06Q 10/00; G06Q 40/00

(52) U.S. Cl. 705/7; 705/35

(57) ABSTRACT

An executive compensation system for a public company that objectively determines every quarter the executive compensation for the executive-group automatically based on input of the compensation policy, revenue, profit, and stock price parameters. The system has functions that objectively and automatically allocates the executive-group compensation into the individual members of the group for the base compensation, incentive compensation, stock grant compensation and benefit compensation.

### CROSS REFERENCE TO RELATED APPLICATIONS

This application claims priority on Provisional Application Ser. No. U.S. 60/517,974, titled “Method and Apparatus for determination of executive compensation in a public company” filed on Nov. 5, 2003, by Tara Chand Singhal. The contents of the Provisional Application Ser. No. 60/517,974 are incorporated herein by reference.

### FIELD OF THE INVENTION

The present invention is directed to a method and apparatus for an automated determination of compensation of executives of publicly traded companies based on objective internal and external factors.

### BACKGROUND

In a corporation, the shareholders of the corporation in annual meetings elect the directors of the corporation. These directors then select and/or approve the executives of the company. The elected directors are organized in a board of directors. The directors elect a chairman of the board, and select/elect the board members with specific responsibilities such as in auditing and compensation as well as set the regular meeting agendas.

During annual shareholder meetings, the company executives recommend the list of directors for election. A significant number of the directors that are recommended for election or reelection are also officers and executives of the company. Since the company executives are supposed to know the business of the company and they answer to the board of directors, the directors that they recommend are usually elected by the shareholders. Most of the time the CEO of the company is also a director and also assumes the position of the Board Chairman

The directors are the shareholder's representatives in managing the company and the shareholders have no say in managing the day-to-day operations of the company including determination of the executive compensation. The shareholders are allowed to vote on only those issues that affect the ownership issues of the company such as acquisitions and mergers.

The compensation committee of the board of directors sets and determines the compensation of the senior executives of a public company. The senior executives of the company set and determine the compensation of the board of directors.

The compensation committee may use their knowledge of the industry and may receive advice from independent consultants to set a fair base compensation based on the type of duties and compensation in similar industries. The compensation committee, while setting the base compensation of the senior executives, may take into account factors such as experience, prior compensation and how much others are paid in the industry in a similar capacity.

The compensation committee also sets and determines incentive compensation as well as benefit compensation. The incentive compensation, also known as performance-based compensation can take many forms, such as cash grants, stock grants, and stock options grants. There is no objective guideline for how to determine and set a fair incentive compensation. Due to an inherent conflict of interest, as identified later, many times the incentive compensation is hugely disproportionate to the efforts of the executive.

Of the many forms of incentive compensations, the stock options grants as well as the exercise of the options do not affect the revenue, profit, assets or liabilities, and hence do not show up on the companies' books. Such grants are only noted as a footnote. Recently there has surfaced abuses concerning the grant of stock options, as well as other forms of incentive compensation. The directors of the compensation committee have a conflict of interest, as they are either the officers of the company or are officers of another company in the same industry and are directors of this company.

Many times than not, the incentive compensation is set arbitrarily and is hugely disproportionate to the contribution of the executive. The stock options grants bear little or no direct relationship to the performance of the executive. For example, if the share price is $10/share and a CEO is given the option to buy 1 million shares at the grant price, and if, due to factors outside the control of CEO, the price drops to $5/share, then the CEO asks the committee to cancel that stock option grant and issue him a new stock option grant at $5/share. If the stock price rebounds back to $10/share due to no effort of the CEO, the CEO has earned an incentive compensation of $5 million based on the stock option grant. In general the stock option grants are hugely disproportionate to the base compensation of the CEO as well as his direct performance in boosting the revenue and profits of the company.

Further, since the stock options grant is so hugely disproportionate, it creates for the CEO and the other executive members the incentive to finagle the operations, the books, the dissemination of material news, and finances of the company, so as to artificially inflate or raise the stock price. Thus, allowing the CEO to cash the stock options when the stock price has risen.

Due to these abuses, the issue of corporate governance has surfaced. A conflict of interest has been discovered between the duties of the board of directors in that they do not serve the shareholders but are more inclined to serve their own interests and the interests of the executives of the company.

There have been many examples of such abuses in the industry based on public news stories. Some notable examples are: TYCO, Enron, WorldCom, NYSE, Freddie Mac, Adelphia, HealthSouth and so on. For example the CEO of NYSE, Dick Grasso, was granted a performance-based compensation of 5 million for a single event of performance and additional performance compensation of 135 million for superlative work in addition to the base compensation salary. There has been a huge outcry in the public for the government and SEC to correct and curb these types of abuses.

In the similar vein, recent abuses in stock option grants that have surfaced concern backdating the stock option grants to artificially inflate the value of the grant. SEC has held many public hearings on how to address these and other corporate governance issues.

As a result, the SEC is recommending that a solution to these corporate governance issues be that some of the directors be independent directors and that the stock options grants be shown as expenses. This is intended for the shareholders to have correct and full information about the compensation of the executives and its affect on the profit and loss of the company. Many companies are adopting corporate governance rules regarding specifying definitions for the independence of the directors. Many companies are having difficulty regarding expensing stock options grants. Some companies are choosing to do so reluctantly, while others are not.

Furthermore Section 162(m) of the IRS code, as amended in 1993, precludes a public corporation from taking a tax deduction for individual compensation in excess of $1M for its CEO or any of its four other highly paid officers. The Section exempts performance-based compensation.

Companies also seek shareholder approval of their stock incentive plans. Such plans merely set aside a pool of shares to be used for incentive compensation. However, all these attempts have been largely ineffective. They have not been barriers, for the NYSE board, in granting a 140 million dollar compensation package to Dick Grasso, the CEO of NYSE. They have also not been barriers in curbing other abuses in many other companies.

Sarbanes-Oxley Act of 2002 on corporate governance does not address the heart of the corporate governance issue, the real issue of runaway compensation, specifically the performance-based compensation. Greed and conflicts of interest have no boundaries and are difficult to regulate. While IRS section 162(m) places guidelines on executive compensation, the performance-based compensation is exempt from these guidelines. Hence there are virtually no guidelines on performance-based compensation.

The shareholders have little choice but to rubber stamp the company's proposed slate of the internal and external directors. The company executives decide the compensation of the directors. The directors decide the compensation of the executives including the performance-based compensation.

The independent directors almost always have full time occupations managing their own companies and life's responsibilities. They are by necessity, at best, minimalist overseers of the corporation's affairs by attending a handful of meetings. To identify a director as an independent because the director is not an officer of the corporation is to ignore human nature. This leads to an inherent conflict of interest. A conflict, solution for which, is not covered in the Sarbanes-Oxley Act, which criminalizes irresponsible actions of corporate officer's.

This conflict of interest leads to stock options grants and other forms of hidden compensation that create for the executives and the directors the incentives to artificially inflate stock price and finagle the company's accounting books to reap a reward hugely disproportionate to their contribution. Stock options grants of million of shares is free money or someone else's money that does not even show up in the expense column of the company's books.

The Black-Scholes Option-Pricing Model or similar accounting methods to evaluate stock options are not only disliked by many of the companies but adds un-necessary complexity and uncertainty to the company's accounting books.

Further complying with and implementing these regulations and recommendations has turned out be difficult due to may reasons such as: (i) options grants are difficult to expense as there is no way of determining the value of the grant at the time of the grant, (ii) the grant is so hugely disproportionate, and when it is exercised, it would materially affect the profit of the company, (iii) estimating the grant value and then adjusting the value at the time of exercise of the grant creates a problem in keeping and balancing the company books and does not create an accurate picture of the revenue and profits of the company, (iv) generally the executives of one corporation serve in the role of director of another corporation in the same line of business and there is no effective way to eliminate the conflict and have truly independent directors, and (v) the company executives determine the compensation of the board of directors.

In light of the above, it is an objective of the present invention to solve the corporate governance issue with regards to determination of compensation of the executives of a public company.

Yet another objective of the present invention is to have a system of executive compensation that is based on objective factors both internal to the company and external to the company.

Yet another objective of the present invention is to provide an automated process to determine the executive compensation, a process that can be audited and made public.

Yet another objective is to provide the shareholders a means to provide input to the determination of executive compensation.

### SUMMARY

The way the executive compensation is currently determined and it's many problems are: (i) the compensation committee of the board of directors determine the compensation of the CEO, (ii) the CEO determines the compensation of the other members of the senior management and the directors themselves, (iii) the shareholders have no say in setting a policy or otherwise determining the compensation of any one, the determination of compensation being a day-day-operation of the company over which the shareholders have no control (iv) the Board can approve and grant compensation in the form of stock option grants, benefits, and other performance driven cash and like compensations that either has no relationship or may be hugely disproportionate, to the efforts of the CEO in improving the value of the company, (v) the boards of directors have a conflict of interest, being also the officers of the company, (vi) external or independent directors have a conflict of interest by having cross-board relationships, (vii) the grant of hugely disproportionate stock option grants creates incentive to artificially inflate the price of the stock by news, market, and book-keeping manipulation, and (viii) the expensing of stock option grants as suggested by the SEC is both a bookkeeping problem and creates its own unintended consequences.

The executive compensation system of this invention solves the problems associated with corporate governance issues related to excessive executive compensation and compensation that is hugely disproportionate to the efforts of the senior management.

This invention is for an executive compensation system for a public company. The system has functions of: (i) executive-group, (ii) group compensation policy, (iii) compensation policy being voted by shareholders, (iv) internal and external objective factors that qualitatively and quantitatively determine the success of the company, and (v) a compensation function that objectively determines the executive-group compensation every fiscal quarter for the executive-group using, the compensation policy, the internal, and the external objective factors. The system also has functions that objectively and automatically allocate the executive-group compensation into the individual members of the executive-group for the base compensation, incentive compensation, stock grant compensation and benefit compensation.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts.

FIG. 1 is a block diagram that illustrates a version of the current invention of the executive compensation system.

FIG. 2 is another block diagram that illustrates a version of the current invention of the executive compensation system.

FIG. 3 is a block diagram that illustrates the compensation policy database of the executive compensation system.

FIG. 4 is a block diagram that illustrates a system that may be used to host the executive compensation system.

FIG. 5 is a block diagram that illustrates a flow chart of the executive compensation system of the current invention.

### DESCRIPTION

A system of executive compensation of this invention in a public company has a group-compensation function that determines a group-compensation for an executive-group of the company.

The executive-group is made up of executive members of the company and may include executive members such as, CEO, CFO, COO, Senior staff, head of divisions, who have profit and loss responsibilities for managing the performance of the company. The executive-group may also include elected directors of the company. Different methods on how to determine the size and members of the executive-group are described later in this disclosure.

The group-compensation is a sum of money that is computed periodically, such as every quarter as a compensation for the entire executive-group based on a plurality of objective factors representing performance of the company in a specified period.

The group-compensation function inputs, (a) a set of compensation policy parameters that have been approved by shareholders of the company and (b) objective factors representing the performance of the company in a specified period, and uses them to compute a group-compensation. The group-compensation function also may have a distribution function that outputs three equal monthly compensation amounts for distribution to each member of the executive-group.

The objective factors may include a plurality of factors from a group of factors of, a gross revenue for a base quarter, rate of change of gross revenue, operating profit for a base quarter, rate of change of operating profit, average stock market valuation for a base quarter, and a rate of change of average stock market valuation.

An executive-group function may be used to determine size and members of the executive-group of the company for the purpose of determining the group-compensation.

The executive-group function may use a plurality of sub-functions from a group of (i) a first sub-function that determines size of the executive-group as a percentage of the employee population of the company, (ii) a second sub-function that determines members of the executive-group as those that are members of an executive council including the members of a board of directors, (iii) a third sub-function that determines size and members of the executive-group from the number of divisions or groups based on product/service/market categories, and (iv) a fourth sub-function that determines the size and the members of the executive-group from the functional groups of the company. Other methods may also be used to determine the size of the executive-group that depend upon what the members of that class of industry thinks who are the executive-group of that class of the company and are directly responsible for the management of the company's performance and set policy objectives and guidelines that affect directly the market performance of the company.

The system of executive compensation of this invention in a public company may also uses a weighting function to facilitate industry wide computations of group-compensation, wherein the weighting may be used to apply a scale factor for the type of the public company such as, service, low tech, high tech, distribution, and sales/marketing, and a company classification such as retail, finance, transportation, utility, and drugs etc.

The system of executive compensation of this invention in a public company may also have a compensation-apportion function, which apportions the executive-group-compensation into the parts of, base compensation, performance driven compensation, and benefit compensation. The system of executive compensation of this invention in a public company may also have an incentive-apportion function that apportions the performance driven compensation into a cash part and a stock grant part, and may also have a benefit-apportion function, that computes the benefit compensation among medical, vacation, miscellaneous, and retirement benefits. Each benefit individually and the composite benefit may be determined as a percent of the group compensation.

The system of executive compensation of this invention in a public company may have a group-compensation-apportion function wherein the group-compensation is apportioned between the members of the executive-group based on the relative importance of the executive function to the company from a group of executive functions of, directors, senior management, marketing function, finance function, sales function, production function, operation function, research and development, and support function.

The system of executive compensation of this invention in a public company also may have a compensation policy function enabling an executive compensation policy to be created. The compensation policy function comprising: an input function that captures as input a plurality of parameters of the compensation policy such as, (i) the percentages of the revenue for a base quarter P1, (ii) percentage of profit for a base quarter P2, (iii) percentage of market valuation for a base quarter P3, (iv) percentage of the change in revenue for a particular quarter from a base quarter P4, (v) percentage of the change in profit for a particular quarter from a base quarter P5 and (vi) percentage of the change in valuation for a particular quarter from a base quarter P6, (vii) the size of the executive-group for which these percentages are applicable, (viii) the apportionment of the compensation of the group between the parts of base and incentive compensation, and (ix) the incentive compensation proportion that is given in cash and that is gives as stock grant.

The compensation policy function further may have a policy database function that saves the policy parameters in a compensation policy database. The compensation policy function further comprising: an approval function that enables some of the compensation policy parameters to be approved at an annual shareholder meeting.

The computed group-compensation may need not be apportioned or distributed in its entirely to the executive-group. A reserve compensation fund may be created and withheld from distribution or apportionment. The amount of such a reserve component may be decided by the directors and or the executives of the company and may be used to account for events such as: some executives leave the company and may forfeit part of their compensation and other executives may join the company who need to be compensated extra; unusual or one time losses or gains in a quarter that should not be used to affect the compensation; unusual fluctuations in revenue and profit caused by the unusual market conditions; and one time events.

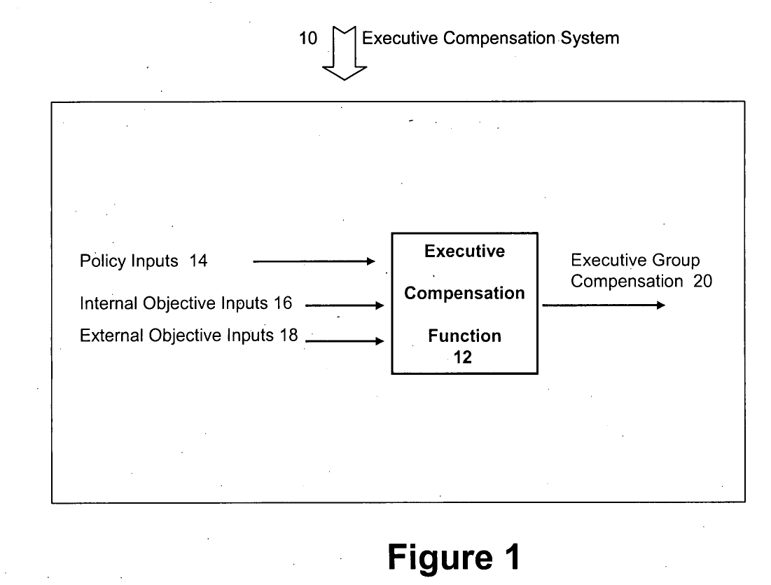

With reference to FIG. 1, the executive compensation system 10 has executive compensation function 12, which has the inputs of, compensation policy parameters 14, internal objective parameters 16 and external objective parameters 18. The function 12 computes executive-group compensation 20 for the executive-group as a whole every fiscal quarter.

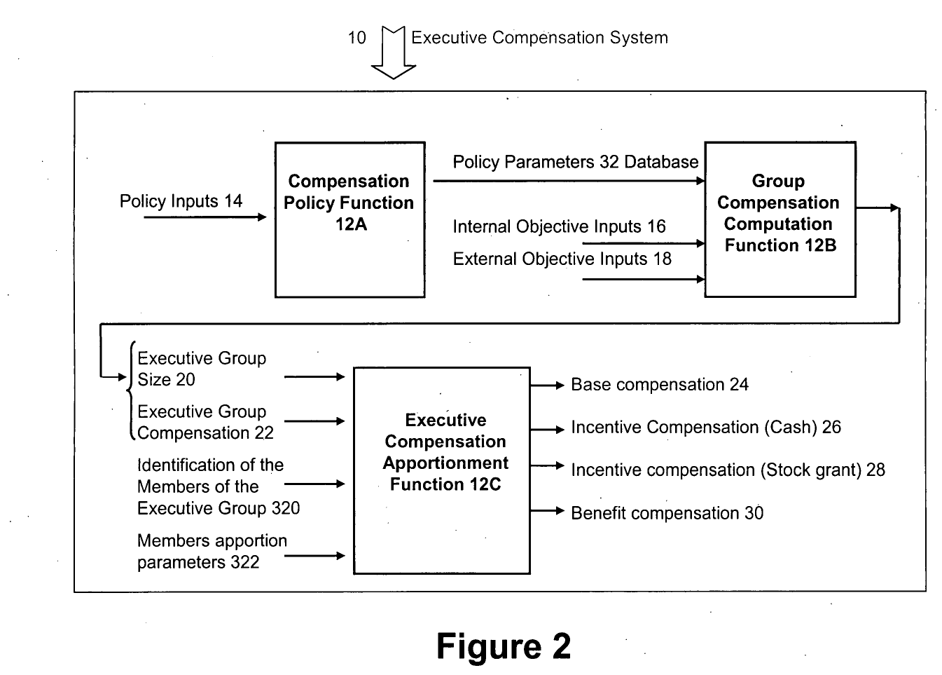

As illustrated with reference to FIG. 2, the executive compensation function 12 may be divided into three sub-functions of, (i) compensation policy function 12A, (ii) group compensation computation function 12B, and (iii) compensation apportion function 12C.

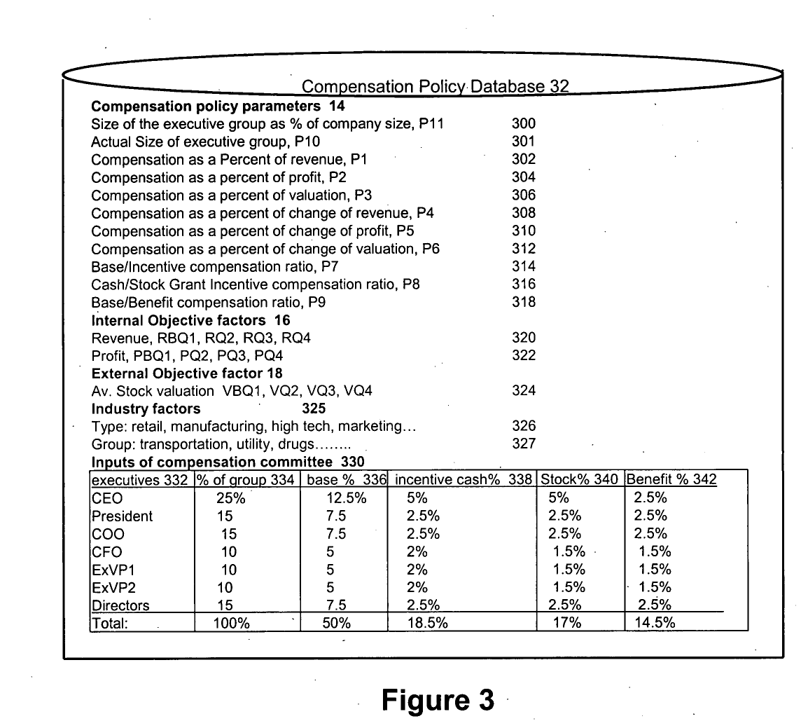

To the function 12A, the compensation policy parameters 14 are input and a policy parameters database 32 is output. The database is identified and described later with reference to FIG. 3. To the sub-function 12B, the database 32, the internal objective inputs 16 and external objective inputs 18 are input and executive-group size 20 and the executive-group compensation 22 are output. To the function 12C, the group compensation 22, the executive-group size 20, the identification of the members of the group 320 and their individual apportion parameters 322 are input. The function 12C outputs the base compensation 24, the cash incentive compensation 26, stock incentive compensation 28, and benefit compensation 30 for each member of the executive-group.

This Compensation policy function 12A may include an input function, a policy database function, an approval function, and an executive-group function. The input function provides means to capture as input a plurality of parameters of the compensation policy from a plurality of inputs by the company. The policy database function saves the policy parameters in a compensation policy database and makes it available to other functions.

The approval function enables the compensation policy parameters to be placed before an annual shareholder meeting for approval by the shareholders. The executive-group function determines size and members of the executive-group of the company for the purpose of determining the compensation of the group as a whole.

This Compensation function 12B may include, a weighting function, and a group compensation computation function. The weighting function may apply empirical weighting to the factors, wherein the weighting may be determined from the type of the public company such as, manufacturing, service, low tech, high tech, distribution, and sales/marketing and industry groups such as transportation, utility, and pharmaceutical. The group compensation computation function computes a quarter's executive compensation for the members of the executive-group using the input from the compensation policy database.

The Executive-group Compensation (EGC) for a quarter may be defined and computed using the equation: EGC={P1×RBQ+P2PBQ+P3VBQ+P4x×RQ2−RBQ)+P5×(PQ2−PBQ)+P6×(VQ2−VBQ)}×SNF×ISF. Where P1 to P6 are policy parameters, R represents revenue, P represents profit, V represents market valuation, Q2 represents 2^{nd} quarter of a fiscal year, and BQ represents a base quarter. SNF is size-normalizing factor for the size of the executive-group and ISF is an Industry Scale factor.

The Compensation-apportion function 12C apportions the executive-group compensation into the parts of, base compensation, incentive (performance driven) compensation, and benefit compensation. Further function 12C may include an incentive-apportion function, a benefit-apportion function, group-apportion function, stock-apportion function and a distribution function.

The incentive-apportion function apportions the group compensation into a base part and an incentive part. The benefit-apportion function apportions the benefit compensation between medical, vacation, miscellaneous, and retirement benefits. Each benefit individually and the composite of these benefits may be determined as a percent of the group compensation. The group-apportion function apportions the group compensation between the members of the executive-group based on the relative importance of the executive function to the company from a group of executive functions of, directors, senior management, marketing function, finance function, sales function, production function, operation function, research and development, and support function. The stock apportion function apportions the performance driven (incentive) compensation into a cash part and a restricted stock grant part. The distribution function outputs three equal monthly compensation amounts for distribution to each member of the executive-group.

The objective parameters are, on a fiscal quarter basis, the revenue, operating profit, and the stock market valuation. The valuation is based on average stock price and the number of issued shares. These parameters quantify and define the success of a public company on which the compensation of the executive-group of a company is based on. A public company may already be computing these parameters as part of their SEC filings on a quarterly basis. Some of the objective parameters are internally determined objective parameters and some are externally determined objective parameters.

The internally determined objective parameters are: (i) revenue for a base quarter, (ii) change of revenue of the current quarter from the previous quarters, (iii) profit for a base quarter, and (iv) change of profit of current quarter from previous quarters. The base quarter may be any quarter or the first quarter of the fiscal year. The change of revenue and profit for a quarter may be either the change in the current quarter from the previous quarter or the change from the base quarter. These are referred to as internally determined objective parameters because a company's executives have direct control of the revenue and the profit based on their contribution to the company. They are objective parameters since they become part of SEC filings and follow established auditable and standard accounting policies.

The externally determined objective parameters are (i) the average stock price for a base quarter, (ii) rate of change of average stock price from the previous quarters, and (iii) the number of issued shares for the quarter. The average stock price multiplied by the average shares issued gives the average stock market valuation for the quarter of the company. These parameters are referred to as externally determined objective parameters because market forces that are external to the company determine the market valuation. The executives have indirect influence on these market forces by dissemination of material news.

The base quarter values may be for the first quarter of the company's fiscal year. Alternatively, the base quarter values may be the average of the four quarters of a base year. Or the base quarter values may be those for which there is general agreement that the base quarter values represent a reasonable basis for judging the future performance of the company. The base quarter may remain the same for a number of years or change every year or be reset when new senior management of the executive-group is put in place.

The change for the parameters of revenue, profit and valuation may refer to values for the current quarter minus the value for the previous immediate quarter. Alternatively, the rate of change may refer to values for the current quarter minus the values for the base quarter.

An executive-group is defined by determining the size and the members of the executive-group of the company. The size and members can be determined by a plurality of sub-functions where (i) a first sub-function determines size of the executive-group as a percentage of the employee population of the company, (ii) a second sub-function determines members of the executive-group as those that are members of an executive council including the directors of the company, (iii) a third sub-function determines size and members of the executive-group from the number of divisions or groups based on product service/market categories, and (iv) a fourth sub-function determines the size and the members of the executive-group from the functional groups of the company.

The executive-group, as defined above consisting of the senior executives, the directors, and the other senior level executives who are directly appointed by the senior executives and assist the senior executives in defining and implementing the strategic direction of the company, is the group most directly responsible for the revenue, the profit and the stock market valuation of the company and should be answerable for the success of the company and to the shareholders by having their compensation being affected by the parameters of a compensation policy that is voted on by the shareholders.

A compensation policy is created by the company and is voted on by the shareholders. In a preferred embodiment, the policy may be recommended by the company executives and voted on by the shareholders for approval. The policy defines policy parameters that enable an executive-group compensation policy to be put in place by the company. The policy has parameters such as: (i) the percentages of the revenue for a base quarter, (ii) percentage of profit for a base quarter, (iii) percentage of market valuation for a base quarter, (iv) percentage of the change in revenue for a particular quarter from a base quarter, (v) percentage of the change in profit for a particular quarter from a base quarter and (vi) percentage of the change in valuation for a particular quarter from a base quarter, and (vii) the size of the executive-group for which these percentages are applicable. The policy may also include parameters such as (viii) the apportionment of the compensation of the group between the parts of base and incentive compensation. The policy may also include, in addition, (ix) the incentive compensation proportion that is given in cash and that is gives as stock grant.

For example, the policy may have the group compensation for a fiscal quarter of (i) 2.5% of the revenue of the company plus (ii) 25% of the profit plus (iii) 1% of the valuation of the company for a base period quarter, (iv) plus 5% percentage of the change of revenue, plus (v) 15% of the change in profit, and (vi) 3% of the change in valuation for the current fiscal quarter over the base quarter for the (vii) executive-group size of 1% of the company, A negative change or decrease in some or all these values for a given quarter compared to the base quarter may produce a negative result and thus reduce the group compensation compared to the base quarter.

The policy parameters may also decide that a percent of the total group compensation be set aside as incentive compensation tied to performance factors. For example, the policy may state (viii) 50% of the group compensation is set aside as incentive compensation. The policy may also state that a (ix) 50% of incentive compensation is given in cash and 50% be given as stock grants. This policy ensures that the executive-group has an ownership interest in the company by a part of the compensation being given in restricted stock grants. The restricted stock grants have restrictions that the stock be held for a certain period of time before they can be sold. The policy may also state that a certain percent of the group compensation be given as benefits. The benefits may include pension, vacation, medical insurance and other perks.

The size of the executive-group is directly linked to the policy parameters of the percentages of the revenue, profit and valuation. One way to set the size of the group is by the percent of the size of the company. The other way is to ask the company to select the size of the group. Since the size of the group would affect the percentages of the revenue, profit and valuation for calculating the group compensation, and the size of the group may be different from company to company, it is preferable to set the group size arbitrarily at 1% and then let the company select it's own executive-group size.

To facilitate this a Size Normalizing Factor (SNF) may then be used. The SNF enables the compensation policy to determine policy parameters without regard to the actual size of the executive-group. Then the SNF may be used to normalize the policy parameters for the actual size of the executive-group. For example, if the size of the group is 100 (1%) for a company size of 10,000, and the company wants the executive-group size to be 90, then a normalizing factor of 90/100=0.9 may be used to adjust all the policy parameters. With the use of the SNF, the percentages of revenue, profit and valuation are all based on the same executive-group size of 1% of the company size.

The executive compensation may differ for companies in different industries, based on the risk, type, or maturity of the company. For example, the executives of a high tech company may need to be paid more than executives of a finance company. To make it easy to select and recommend policy parameters, an Industry Scale Factor (ISF) may be used. For example, the ISF scale factor would normalize the difference in the types of industry such as manufacturing, service, sales/marketing etc. For example, if a distribution company executives command a lower compensation in the marketplace than the executives of a high tech company, then an appropriate ISF may be used to adjust the executive-group compensation with the policy parameters. The use of ISF enables the policy parameters to remain same or similar for different types of the companies.

The executive-group compensation system 10 of this invention may merely act as an upper bound to the grant of compensation to individual executives of the company by the directors of the company by putting an upper bound to the amount of compensation to be granted to the executive-group as a whole. Therefore, the system 10 is intended to curb the abuses of runaway compensation as has been the case based on published news stories. The executive-group compensation system of this invention may include stock grants but does not include stock option grants. The directors and the executives of the public company would have complete discretion and control on how to set and award the various forms of compensation to each member of the executive-group within the bound of group compensation set and computed by the compensation policy. Therefore, the actual compensation that is awarded may be less than the executive-group compensation, and may be set aside as a reserve compensation to be used in the future.

As illustrated in FIG. 2, the compensation policy parameters, as defined above may be input into a policy function 12A that creates and outputs an executive compensation policy database 32. Additionally and optionally, the policy database may also include other data that would enable the group compensation and individual compensation to be computed. The other data may include on a quarterly basis, the revenue, profit and average stock price, and number of outstanding shares. This other data may be input into the policy database by the audit committee. The other data may also include apportionment of the group compensation among the members of the executive and for each member the proportion of, base compensation, cash grant cash compensation, stock grant compensation, and benefit compensation Individual apportionments of base, incentive, cash, stock and benefit are decided solely by the company and the compensation committee and may differ substantially from member to member. However, in the aggregate they comply with the compensation policy. This other data may be input by the compensation committee. These and other aspects of the compensation policy database are described in more detail later with reference to FIG. 3.

With reference to FIG. 3, the policy database 32 may contain compensation policy parameters 14, internal objective factors 16, external objective factors 18, industry factors 325, and compensation committee inputs 330. These are described here in detail.

The compensation policy parameters 14 may be: P11, size of executive-group as a percentage of company size 300, P10, the actual size of the executive-group or as proposed by the company 301, P1, compensation as a percent of revenue, 302, P2 compensation as a percent of profit 304, P3 compensation as a percent of market valuation 306, P4 compensation as a percent of change of revenue 308, P5 compensation as a percent of change of profit 310, P6 compensation as a percent of change of valuation 312, P7 base/incentive compensation ratio 314, P8 cash/stock grant incentive compensation ratio 316, and P9 base/benefit compensation ratio 318.

The internal objective factors 16 are: revenue for the base quarter and each other quarter that is available, identified as, RBQ1, RQ2, RQ3, RQ4 320, and profit for the base quarter and each other quarter as, PBQ1, PQ2, PQ3, PQ4 322.

The external objective factors 18 are: average stock market valuation identified as, VBQ1, VQ2, VQ3, and VQ4 324. The industry factors 325 are: industry type such as, retail, manufacturing, sales/marketing 326 and industry groups such as transportation, utility, drugs 327.

The inputs of compensation committee 330 are: names of executives 332, % of group compensation awarded to the member of the group 334, base compensation % awarded to the group member 336, cash incentive compensation % awarded to the group member 338, restricted stock grant incentive compensation % awarded to group member 340, and benefit split awarded for each group member 342.

In FIG. 3, the aggregate of the group % 334, the base % 336, the incentive cash % 338 and % incentive stock grant % 340, and benefit % 342, may fully comply with the compensation policy, while at the same time the compensation committee and the company executives have complete and full discretion and control on how these are split among the different members of the executive-group including the directors of the company. For example, FIG. 3 shows as a simplified illustration that the CEO may be awarded 25%, the President 15%, the COO 15%, the CFO 10%, the ExVP1 10%, the ExVP2 10% and the directors as a group 15% for a total of 100% of the group compensation.

The operation of the executive compensation system 10 for computing the executive-group compensation and the use of the compensation policy database can be further understood with the help of the following simplified example.

Let us assume the company size is 1000 employees. Also assume for a base year, revenue of 1 Billion (RBY), earning: 125 Million, (EBY) and the average Market Valuation (MBY) for the year was 2.5 Billion.

Also assume for next year, first quarter, Revenue of 260 Million (RCYQ1), Earnings: 30 Million, (ECYQ1) and the average Market Valuation (MCYQ1) for the quarter is 2.4 Billion.

Let us assume, for this type of company and at this stage of their success, size of the company in the market place, the company proposes, the relative weights of the company's success for a 1% size executive-group on which the executive-group compensation expressed as policy parameters P1 to P8 should be as follows:

### For Base Year

### P1 (% of Revenue)=0.5%

### P2 (% of Earnings)=5%

### P3 (% of Market Valuation)=0.25%

### For Next Year

### P4 (% of change in Revenue)=1.0%

### P5 (% of change in Earnings)=10%

### P6 (% of change in Valuation)=0.1%

### P7=50/50 Base/incentive ratio

### P8=80/20 Cash/Stock ratio.

The company proposes a size of the executive-group=12, made up of 5 independent directors, CEO, CFO, President, EXVP1, EXVP2, Treasurer, and Chief Legal Counsel.

Then, Size Normalizing Factor, (SNF)=Proposed Size divided by 1% size=12/10=1.2 is computed. Also assume Industry Normalization Factor, ISF=1.0. Executive-Group Compensation (EGC) for the base year and the next year, each quarter may be calculated as follows:

EGC for Base Year=(P1×RBY+P2×EBY+P3×MBY)×SNF'ISF=(0.5%×1B+5%×125M+0.25%×2.5 B)×1.2×1.0=21.6M

### EGC for Current Year, First Quarter

### Is one fourth of base year plus the change every quarter compared to the corresponding quarter of the base year and is =21.6M/4+P4×(RCYQ1−RBYQ1)+P5×

$$\begin{matrix}\begin{matrix}( ECYQ 1 - EBYQ 1 ) + \\ P 6 \times ( VCYQ 1 - VBY )\end{matrix} = 5.4 M + 1 \% \times ( 10 M ) + 10 \% \times \\ ( 5 M ) + 0.1 \% \times ( - 100 M ) \\ = 5.4 M + 0.1 M + 0.5 M - 0.1 M = 5.9 M\end{matrix}$$

The compensation committee may split the EGC in base, performance, benefits and perks in any proportion they choose, and may also set aside a reserve for future use. The committee may apportion the EGC among the members of the executive-group in any proportion they choose. Based on the compensation policy, of the EGC, the compensation committee must award P7 (50%) as incentive compensation and P8 (20%) in restricted stocks in aggregate to the executive-group.

If the compensation committee decides that CEO has a 25% share of the EGC, Five directors have 10% share, CFO has 15.0% share, President has 20.0%, ExVp1 has 10.0%, Exvp2 has 10.0%, Treasurer has 5.0%, and Chief Counsel has 5.0%. Then, Total Compensation for each member of the executive-group for this quarter is as:

| | |
|---|---|
| CEO = 1.475M | Five Directors = 0.59M |
| President = 1.18M | CFO = 0.79M |
| ExVP1 = 0.59M | ExVP2 = 0.59M |
| Treasurer = 0.295M | Chief Counsel = 0.295M |

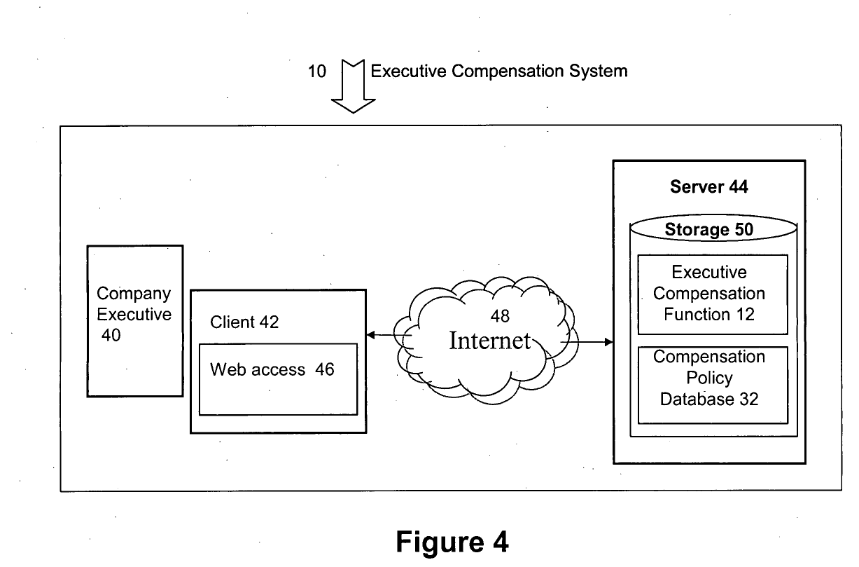

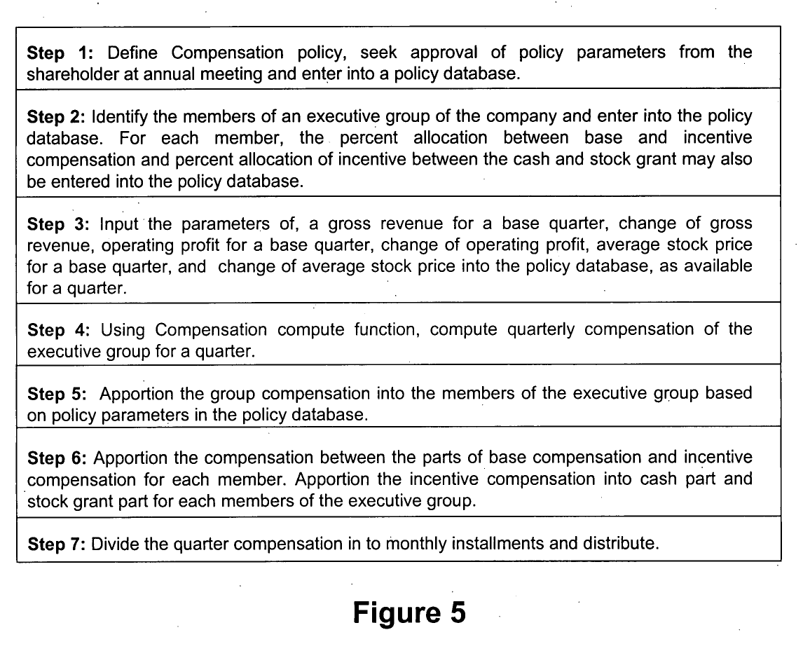

The system 10 may be deployed within a company's business systems where the function 12 is hosted on a server connected to a client. Alternatively, as described in FIG. 4, the company executives 40 may access the compensation function 12 and the policy database 32, on an Internet server 44 via client 42 with web access 46. The operational steps of the executive compensation system 10 are described with reference to FIG. 5.

As illustrated in FIG. 4, the executive compensation system 10 may be implemented where there is a client connected to a server, where the server hosts an executive compensation system; the server having a receiving function capable of receiving (i) inputs of compensation policy, (ii) revenue and operating profit on a quarterly basis, and (iii) average stock price for a quarter from the client.

The system further may have the server having a computation function computing the executive compensation for an executive-group for a quarter, the server having an output function sending to the client the group compensation for the quarter.

The system further may have the server having a receiving function capable of receiving (i) inputs of name of an executive, (ii) executive's function from a group of functions and (iii) relative weighting factors for the executive; the server having a computation function computing the executive compensation for the executive for a quarter; the server having an output function sending to the client the individual executive compensation for the quarter.

The system may further have the server having a receiving function capable of receiving (i) inputs of name of an executive, and (ii) relative weighting factors for the executive for different types of compensation; the server having a computation function computing the executive compensation for different types of compensation for the executive for a quarter; the server having an output function sending to the client the individual executive compensation for different types of compensation for the quarter.

With respect to FIG. 4, the executive compensation system has a client 42 connected to a server 44, where the server hosts an executive compensation system function 12. The server 44 has a receiving function capable of receiving (i) inputs of compensation policy, (ii) revenue and operating profit on a quarterly basis, and (iii) average stock price for a quarter from a company officer 40 via the client 42.

The server 44 has a storage means 50 for storing compensation policy database 32 and the compensation functions 12 that compute the group compensation. The client 42 may have a web access means 46 for connection to the server 44 on a global computer network 48.

There may be multiple methods for implementing the executive compensation of this invention in a public company. The methods may have the following steps: (a) determining the members of the executive-group managing the performance of the company and may include members such as, CEO, CFO, COO, Senior staff, head of divisions, who have profit and loss responsibilities and directors; (b) creating an executive compensation policy represented by a set of parameters; (c) approving, by the shareholders of the company, the compensation policy; and (d) computing a group-compensation based on a plurality of objective factors representing performance of the company in a period and the set of compensation policy parameters.

The method also has the steps of: apportioning the executive-group-compensation into the parts of, base compensation, performance driven compensation, and benefit compensation.

The method also has the steps of: apportioning further the group-compensation between the members of the executive-group based on the relative importance of the executive function to the company from a group of executive functions of, directors, senior management, marketing function, finance function, sales function, production function, operation function, research and development, and support function. The method comprising the steps of: apportioning further the group-compensation between the individual members of the executive-group based on the relative importance of the individual to the company.

Another method that determines executive compensation in a public company has the step of: presenting a compensation policy for annual shareholder approval, where the policy specifies an executive-group of the company and determines executive-group compensation on a quarterly basis.

The method further has the step of: computing the executive-group compensation as a function of a plurality of factors of, a gross revenue for a base quarter, rate of change of gross revenue, operating profit for a base quarter, rate of change of operating profit, average stock price for a base quarter, and a rate of change of average stock price.

The method has the steps of: (a) apportioning the executive-group compensation between the parts of base compensation and incentive compensation; and (b) apportioning the incentive compensation into the parts of cash grant and stock grant compensation.

The operation of the executive-group compensation system 10 can be further understood with reference to the flow chart illustrated in FIG. 5. Importantly, the order of some or all of the steps can be varied. Further, not all of the steps outlined below may be necessary to perform executive-group compensation determination pursuant to the present invention.

### Step 1: Define compensation policy, seek approval of policy parameters from the shareholder at annual meeting and enter into a policy database.

Step 2: Identify the members of an executive-group of the company and enter into the policy database. For each member, the percent allocation between base and incentive compensation and percent allocation of incentive between the cash and stock grant may also be entered into the policy database.
Step 3: Input the parameters of, a gross revenue for a base quarter, change of gross revenue, operating profit for a base quarter, change of operating profit, average stock price for a base quarter, and change of average stock price into the policy database, as available for a quarter.

### Step 4: Using compensation compute function, compute quarterly compensation of the executive-group for a quarter.

### Step 5: Apportion the group compensation into the members of the executive-group based on policy parameters in the policy database.

Step 6: Apportion the compensation between the parts of base compensation and incentive compensation for each member. Apportion the incentive compensation into cash part and stock grant part for each members of the executive-group.

### Step 7: Divide the quarter compensation in to monthly installments and distribute.

This invention benefits the publicly traded companies and does not in any way limit the company's freedom to operate. There are many significant benefits.

Companies already budget and plan compensation budgets and policies and have shareholders approve stock compensation plans. This invention provides for a shareholder approved Executive-group Compensation Policy.

The perceived or real conflict of interest is hard to overcome in attempting to find external dis-interested directors. This invention eliminates conflict of interest between a company's executives and its directors.

Performance-based compensation is tied to the success of the company. This invention supplement and help that process by using industry standard factors for the size and relative success of the company in the marketplace.

Companies have trouble dealing with expensing stock option grants in the current climate. This invention does not use this as a category of compensation, for which no readily ascertainable value exists, while leaving all forms of compensation with a readily ascertainable value available to be used.

Company is in charge of proposing an EGC policy to shareholders and can propose the relative weights of Earnings, Revenue and Market Valuation to which the group compensation should be tied. The policy based on this invention is flexible and adjustable. It can be changed every year and has a safety mechanism for extraordinary circumstances.

The EGC Policy benefits the shareholders in ways such as: (a) Shareholders approve the EGC Policy, (b) Executive-Group Compensation is determined in part as a percentage of the increase in Revenue, Earnings and Valuation, and (c) Shareholders approve the percentage of the executive-group compensation to be given as an aggregate in restricted stocks of the company.

Hence, in this invention, there are benefits to each of the stakeholders of a public company, the shareholders, the company, and the industry at large. Without getting involved in the management and operation of the corporation, shareholders play a role in setting an Executive-Group Compensation policy. Directors and executives have total freedom to measure the value of each executive and award him/her appropriate compensation in any form such as: perks, benefits, base, incentive, retirement, restricted stocks, and deferred compensations. Bring uniformity and objectivity by using industry standard factors of the size and the relative success of the company in the marketplace to determine group compensation of an executive-group.

In summary, the executive compensation system 10 automatically and objectively determines the executive compensation for the executive-group, based on the input of compensation policy, the revenue, profit and stock price data on a quarterly basis. The compensation policy is voted at an annual meeting of shareholders. The system 10 thus eliminates the corporate governance issues where a compensation committee made of directors subjectively determines the executive incentive compensation.

While the particular method and system as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

What is claimed is:

1. A system of executive compensation in a public company comprising:
a group-compensation function that determines a group-compensation for an executive-group of the company.

2. The system as in claim 1, the executive-group comprising:
executive members such as, CEO, CFO, COO, Senior staff, head of divisions, who have profit and loss responsibilities for managing the performance of the company and may include directors.

3. The system as in claim 1, the group-compensation comprising:
a sum of money computed periodically based on a plurality of objective factors representing performance of the company in a specified period.

4. The system as in claim 1, the group-compensation function comprising:
a. a set of compensation policy parameters approved by shareholders of the company;
b. objective factors representing the performance of the company in a specified period;
c. a function using (a) and (b) as inputs computes the group-compensation.

5. The system as in claim 4, the objective factors comprising:
a plurality of factors from a group of factors of, a gross revenue for a base quarter, rate of change of gross revenue, operating profit for a base quarter, rate of change of operating profit, average stock market valuation for a base quarter, and a rate of change of average stock market valuation.

6. The claim as in 4, further comprising: an executive-group function that determines size and members of the executive-group of the company for the purpose of determining the group-compensation.

7. The system as in claim 4 further comprising: a weighting function wherein the weighting may determine the type of the public company such as, service, low tech, high tech, distribution, and sales/marketing, and a company classification such as retail, finance, transportation, utility, and drugs.

8. The system as in claim 4, further comprising: a compensation-apportion function, which apportions the executive-group-compensation into the parts of, base compensation, performance driven compensation, and benefit compensation.

9. The system as in claim 4, further comprising: a group-compensation-apportion function wherein the group-compensation is apportioned between the members of the executive-group based on the relative importance of the executive function to the company from a group of executive functions of, directors, senior management, marketing function, finance function, sales function, production function, operation function, research and development, and support function.

10. The claim as in 4, further comprising: a compensation policy function enabling an executive compensation policy to be created and of the compensation policy parameters to be approved at an annual shareholder meeting.

11. A method of executive compensation in a public company comprising step of:
a. determining the members of the executive-group managing the performance of the company and may include members such as, CEO, CFO, COO, Senior staff, head of divisions, who have profit and loss responsibilities and directors;
b. creating an executive compensation policy represented by a set of parameters;
c. approving, by the shareholders of the company, the compensation policy;
d. computing a group-compensation based on a plurality of objective factors representing performance of the company in a period and the set of compensation policy parameters.

12. The method as in claim 11, comprising the steps of:
apportioning the executive-group-compensation into the parts of, base compensation, performance driven compensation, and benefit compensation.

13. The method as in claim 12, comprising the steps of:
apportioning further the group-compensation between the members of the executive-group based on the relative importance of the executive function to the company from a group of executive functions of, directors, senior management, marketing function, finance function, sales function, production function, operation function, research and development, and support function.

14. A method that determines executive compensation in a public company comprising the step of:
presenting a compensation policy for annual shareholder approval, where the policy specifies an executive-group of the company and determines executive-group compensation on a quarterly basis.

15. The method as in claim 14, further comprising the step of:
computing the executive-group compensation as a function of a plurality of factors of, a gross revenue for a base quarter, rate of change of gross revenue, operating profit for a base quarter, rate of change of operating profit, average stock price for a base quarter, and a rate of change of average stock price.

16. The method as in claim 14, further comprising the steps of:
a. apportioning the executive-group compensation between the parts of base compensation and incentive compensation;
b. apportioning the incentive compensation into the parts of cash grant and stock grant compensation.

17. An executive compensation system comprising:
a client connected to a server, where the server hosts an executive compensation system;
the server having a receiving function capable of receiving (i) inputs of compensation policy, (ii) revenue and operating profit on a quarterly basis, and (iii) average stock price for a quarter from the client.

18. The claim as in 17, further comprising:
the server having a computation function computing the executive compensation for an executive-group for a quarter;
the server having an output function sending to the client the executive-group compensation for the quarter.

19. The claim as in 18, further comprising:
a. the server having a receiving function capable of receiving (i) inputs of name of an executive, (ii) his function from a group of functions and (iii) relative weighting factors for the executive;
b. the server having a computation function computing the executive compensation for the executive for a quarter;
c. the server having an output function sending to the client the individual executive compensation for the quarter.

20. The claim as in 19, further comprising:
a. the server having a receiving function capable of receiving (i) inputs of name of an executive, and (ii) relative weighting factors for the executive for different types of compensation;
b. the server having a computation function computing the executive compensation for different types of compensation for the executive for a quarter;
the server having an output function sending to the client the individual executive compensation for different types of compensation for the quarter.
